(19) United States
(12) Patent Application Publication
(10) Pub. No.: US 2023/0001973 A1
(43) Pub. Date: Jan. 5, 2023

(54) FOLDING PUSH CART

(71) Applicant: Zenithen USA LLC d/b/a Z Company, Upland, CA (US)

(72) Inventors: Andrew David Frankel, Yorba Linda, CA (US); Shi-Ping Zheng, Fuzhou (CN); Tian-Xia Zheng, Fuzhou (CN)

(73) Assignee: Z Company/Zenithen

(21) Appl. No.: 17/356,694

(22) Filed: Jun. 24, 2021

(51) Int. Cl. B62B 3/02; B62B 3/00

(52) U.S. Cl. CPC B62B 3/02; B62B 3/007; B62B 3/003; B62B 2205/04; B62B 2205/06; B62B 2205/20

(57) ABSTRACT

A folding push cart that includes a cart body frame and a storage bag. The front, rear, left, and right vertical surfaces of the cart body frame each includes more than one set of cross-hinged diagonal rods. The bottom of the cart body frame is hinged on the hinge base. The bottom plane of the cart body frame is supported by two left and right folding rod groups, which are hinged on the horizontal slot of the hinge seat on the front and rear vertical surfaces. When opened in place, it can be supported, and it also has a correcting effect on the hinge seat.

### BACKGROUND OF THE INVENTION

### Field of the Invention

The invention belongs to the field of transportation equipment, particularly relating to a type of folding push cart. It is especially related to a solution capable of being folded into a bundle.

### Technical Background

There are many existing folding push cart (or pushcart) schemes, which can be roughly divided into two categories. The first type is a one-dimensional flat folding type. The left and right sides are supported by telescopic rods, and the front and rear vertical surfaces of the vehicle body can be folded together and unfolded. For example:

Chinese patent application CN2014800420171 discloses a type of foldable pushcart, which has a foldable frame that can be positioned at an open position and a folded position and is connected to multiple wheels of the foldable frame. A plurality of substantially rigid seats pivotally coupled to the foldable frame, and a flexible housing forming a side wall for the push cart around the foldable frame. Each substantially rigid seat has a substantially rigid seat back and a substantially rigid seat bottom hinged to the seat back. The supports on both sides of the folding frame are composed of two hinged quadrilateral rods, which can be lifted and folded along the neutral surface.

And Chinese patent application CN201922213235.X discloses a type of easy-to-use foldable push cart, including a frame body, a wheel assembly, and a handle assembly. Both the left and right sides of the frame body adopt a telescopic structure that can be retracted front and rear, so that the frame body can be folded front and rear or unfolded. The front and rear telescopic structure is actually a group of two cross diagonal rods. The upper and lower ends are hinged with the front and rear vertical surfaces, forming a telescopic structure from the front and rear vertical surfaces to the neutral vertical surface.

The second type has two-dimensional folding, which can be folded into bundles. The four vertical surfaces of the front, rear, left, and right can be folded together and unfolded. Another type is called three-dimensional folding, which is easier to store than the former type. For example:

Chinese patent application CN201310648758.1 discloses a type of foldable push cart, including a foldable cart body frame and a storage bag. The cart body frame includes a side bracket and a supporting bottom frame. The side bracket is composed of two crossed and centrally hinged connecting rods. The supporting bottom frame includes a supporting bottom rod and a central hinge base. It is characterized by a side support that includes at least two pairs of corresponding hinged connecting rods to form a corresponding multi-level connecting rod structure. Along with this are corresponding connecting rod ends that are hinged to form a bag body supporting end. The storage bag is provided with a fixed bag opening corresponding to the downward opening. The inner bottom of the storage bag is provided with a lifting piece corresponding to the position of the central hinge base that folds the vehicle body by lifting. In addition, in this structure, telescopic connecting rods are arranged between the upper and lower hinge bases at the four corners of the cart body frame to enhance the overall structural strength and bearing capacity.

Another example is Chinese patent application CN201720694972.4, which discloses a type of retracting and folding push cart, including a frame assembly, a tie rod assembly and wheels. The tie rod assembly is arranged in front of the frame assembly, and the side frames all include the same plane X cross tube assembly. The same plane X cross tube assembly includes an elongated, inclined tube, a short inclined tube and a hollow seat. The middle of the hollow seat is provided with a long hole along the front and rear direction. The front and rear ends of the hollow seat are respectively provided with pipe ports facing oppositely along the vertical direction. The long oblique pipe passes through the long hole and is hinged at the center of the long hole through a hinge shaft. There are two short oblique pipes. The two short oblique pipes are respectively installed in the pipe joints at the front and rear ends of the hollow seat. The two short oblique pipes are arranged parallel to each other and form a cross X shape with the long oblique pipe. The elongated, inclined tube, the two short inclined tubes and the hollow seat are all on the same plane. This structure mainly improves the cross-pipe structure and the articulation method. The overall structure is consistent with the existing patents. It also includes telescopic supports arranged at the four corners between the upper and lower supports and the inner and outer guide pipes. The front and rear bottom beams are also hinged on the flip seat at the center of the vehicle bottom to form an X structure, which can be lifted and folded from the flip seat.

In the existing two-dimensional folding schemes, telescopic rods are provided between the upper and lower hinge bases at the four corners. Because the rods are easily deformed after being loaded, the expansion and contraction are not smooth, which affects the user experience. In addition, the push-pull rods also need to be hinged on the two hinged bases on the front vertical surface through two connecting rods to meet the synchronous opening and folding functions of the front vertical surface. Undoubtedly, the use of more rods will inevitably increase the overall weight. Determining how to improve upon the inefficiencies of the current technology is a focus of this research and invention.

### SUMMARY OF THE INVENTION

A purpose of the present invention is to invent a folding pushcart that can be folded more smoothly by matching and guiding the folding rod group and the hinge base on the bottom plane.

The technical plan of this invention was completed in one or more the following manners:

A folding push cart includes a foldable cart body frame and a storage bag sleeved on the cart body frame. The cart body frame has four vertical surfaces: front, rear, left, and right. It also has a bottom plane, wherein the front, rear, left and right sides of the four vertical surface include a set of more than one set of diagonal rods with cross articulation in the middle. The front vertical surface of the cart body frame is also provided with a push-pull rod assembly. It is characterized by the bottom plane of the body frame supported by two folding rod groups distributed in left and right directions. The folding rod group includes a front rod, a rear rod, and a bridging piece. The bridging piece connects one end of the front rod and the rear rod. The other end of the front rod and rear rod are hinged on the hinge bases on the front and rear vertical surfaces. The hinge bases are correspondingly formed with horizontal slots. When the cart body frame is opened in place, the front and rear rods are partially placed in the horizontal slot and supported.

The hinge base is correspondingly formed with an inclined slot at the hinge position where the diagonal rods of the adjacent vertical surface are hinged. The bottom of the inclined slot is provided with a stud at the notch. When the cart body frame is opened in place, the diagonal rods can be stopped by the stud.

The length of the horizontal slot and the inclined slot on the hinge base is greater than 3 cm, and the slot walls on both sides can form constraints on the corresponding front and rear rods or diagonal rods.

The casters installed on the two hinge bases on the rear vertical surface are directional casters, and the casters are directly locked on the hinge bases through the caster frame. The casters installed on the two hinge bases of the front vertical surface are steering casters. The caster frame is positioned on the hinge bases through the rotation shaft, and the length of the horizontal slot on the hinge base is between 8 cm and 12 cm.

The front and rear rods and diagonal rods are all square-like pipe fittings. At least two of the sides used for hinged joints have a planar structure, which can fit and be restrained relative to the two slot walls of the horizontal slot and the inclined slot. The bridging piece used to bridge the ends of the front and rear rods is formed as a clamping slot with a connecting part on the upper part. The upper part is clamped on both sides of the ends of the front and rear rods with the aid of the clamping slot, and can be rotated and riveted by rivets. When the rear rod is opened to a horizontal position, its upper part is contacted by the connecting part, restricting the continued downward movement.

The middle of the two diagonal rods on the front vertical surface of the cart body frame are cross-hinged with a plastic part base. The plastic part base is formed with a slot hole that is staggered and can pass through the two diagonal rods. The diagonal rods partially rest on the bottom of the slot hole to form a restraint and strengthened support. The plastic part base is also formed with an elastic clamp facing forward, and the push-pull rod assembly is clamped by the elastic clamp to maintain the push-pull rod assembly in an upright state.

The push-pull rod assembly includes a pull rod and a slide bushing base. The slide bushing base is rotatably positioned on the plastic part base through a riveting shaft and is provided with a retractable waist section corresponding to the elastic clamp of the plastic part base. When the push-pull rod assembly swings in the upright state, the elastic clamp can be clamped on the waist section to form a positioning structure. When the pull rod passes through the slide bushing base, the lower end is locked with the limit sheath, the upper end is bent with a handle, the pull rod is pulled up to a designed height, and the limit sheath is in contact with the lower edge of the slide bushing base to form a pulling force transmission effect.

Near the lower end of the pull rod is a bidirectional spring pin, which includes a spring that crosses the through hole of the pull rod and a ball pin provided at both ends of the spring. When the pull rod is pulled up to the designed height, the ball pin springs into the pinholes reserved on both sides of the slide bushing base to form a locking structure.

The pin hole on the slide bushing base is a penetrating hole, and an unlocking reed is provided on both sides of the slide bushing base. The stud on the inner surface of the unlocking reed extends into the pin hole. When the unlocking reed is pressed, the stud moves inward and abuts on the ball pin of the bidirectional spring pin, forcing the ball pin to retreat and unlock.

The storage bag is set on the cart body frame, which means that the upper edge is hung on each hinge point at the upper end of the diagonal rod. The lower edge is fixed on the front and rear rods, and the bottom is tightened by the folding rod groups on both sides. A lifting webbing is sewn on the inner bottom of the storage bag at the position of the corresponding bridging piece.

The invention has the characteristics of unique conception, simple structure, and smooth operation. In particular, the collaboration between the horizontal slot on the hinge base and the rods is used to form a reasonable caster guiding effect. The defects in the prior art of setting telescopic rods at the four corners is omitted. It greatly improves the smoothness of opening. In addition, the push-pull rod assembly is optimized to overcome the shortcomings of the two lower rods in the traditional technology that require the connection of the two lower rods without changing the use experience, and further reducing the overall weight, making the push cart more compact and lightweight.

### BRIEF DESCRIPTION OF THE DRAWINGS

FIG. 1 shows a schematic diagram of the folding push cart.

FIG. 2 shows a zoomed schematic diagram of Selection A from FIG. 1.

FIG. 3 shows a schematic diagram of the folding push cart body frame.

FIG. 4 shows a zoomed schematic diagram of Selection B from FIG. 3.

FIG. 5 shows a zoomed schematic diagram of Selection C from FIG. 3.

FIG. 6 shows a schematic diagram of the hinge base.

FIG. 7 shows a schematic diagram of the folding push cart in a collapsed state.

FIG. 8 shows a schematic diagram of the relationship between the bottom plane of the cart body frame and the push-pull rod assembly.

FIG. 9 shows a zoomed schematic diagram of Selection D from FIG. 8.

FIG. 10 shows a partial cross-sectional schematic diagram of the relationship between the pull rod and the slide bushing base.

FIG. 11 shows a schematic diagram of the relationship between the bottom plane of the cart body frame and the push-pull rod assembly.

FIG. 12 shows a schematic diagram of the folding rod group.

FIG. 13 shows a schematic diagram of the folding rod group in a collapsed state.

Similar reference characters denote corresponding features consistently throughout the attached drawings. Namely, in the drawings the following reference numbers refer to the following part:

| | |
|---|---|
| 100 | Cart body frame |
| 1 | Diagonal rod |
| 2 | Hinge base |
| 21 | Horizontal slot |
| 22 | Inclined slot |
| 221 | Stud |
| 3 | Caster |
| 31 | Caster farme |
| 32 | Rotation shaft |
| 4 | Push-pull rod assembly |
| 41 | Pull rod |
| 411 | Limit sheath |
| 412 | Handle |
| 413 | Through hole |
| 42 | Slide bushing base |
| 421 | retractable waist section |
| 422 | Pin hole |
| 43 | Bidirectional spring pin |
| 431 | Spring |
| 432 | Ball pin |
| 44 | Unlocking reed |
| 441 | Stud |
| 5 | Folding rod group |
| 51 | Front rod |
| 52 | Rear rod |
| 53 | Bridging piece |
| 531 | Connecting part |
| 532 | Chamfer |
| 6 | Plastic part base |
| 61 | Slot hole |
| 62 | Elastic clamp |
| 7 | Riveting shaft |
| 200 | Storage bag |
| 201 | Lifting webbing |

### DETAILED DESCRIPTION OF THE PREFERRED EMBODIMENT(S)

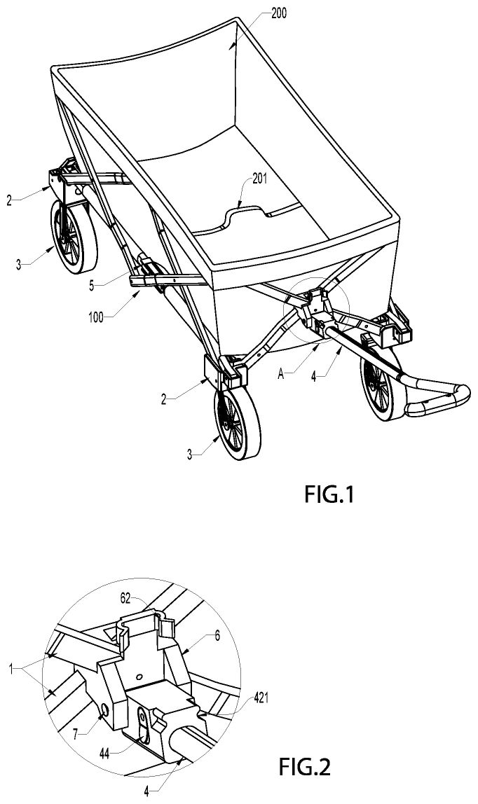

Referring now to FIGS. 1, 3, and 7, the folding push cart includes two main parts: a foldable cart body frame 100 and a storage bag 200 that is sleeved outside the cart body frame. The cart body frame 100 has four vertical surfaces: front, rear, left, and right, and a bottom plane, constituting a frame with an opening facing upwards. The front, rear, left, and right sides of the four vertical surfaces include a set of more than one set of diagonal rods 1 that are cross-hinged in the middle. The upper ends of the diagonal rods 1 of adjacent vertical surfaces are hinged to each other, and the lower end is hinged to the hinge base 2, and casters 3 are installed on the hinge base 2, and the push-pull rod assembly 4 is installed on the front vertical surface of the cart body frame 100. The cart body frame 100 is supported by the cross, diagonal bars 1 in the four vertical surfaces, and can be folded together. Generally, the front and rear vertical surfaces of the cart body frame 100 are a set of crossing diagonal bars 1, the left and right vertical surfaces are two sets of crossing diagonal bars 1, and the ends of the two sets of crossing diagonal bars 1 are directly hinged to form a rectangular frame to make it most practical. Of course, one skilled in the art would recognize that it does not rule out the use of three sets of crossing diagonal bars on the left and right sides of the vertical surface, combined into a longer cart body structure, to meet the needs of carrying special products.

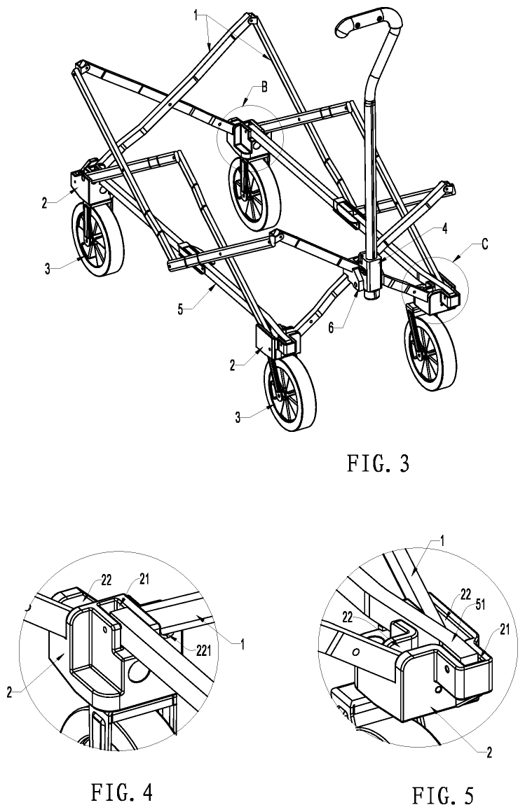

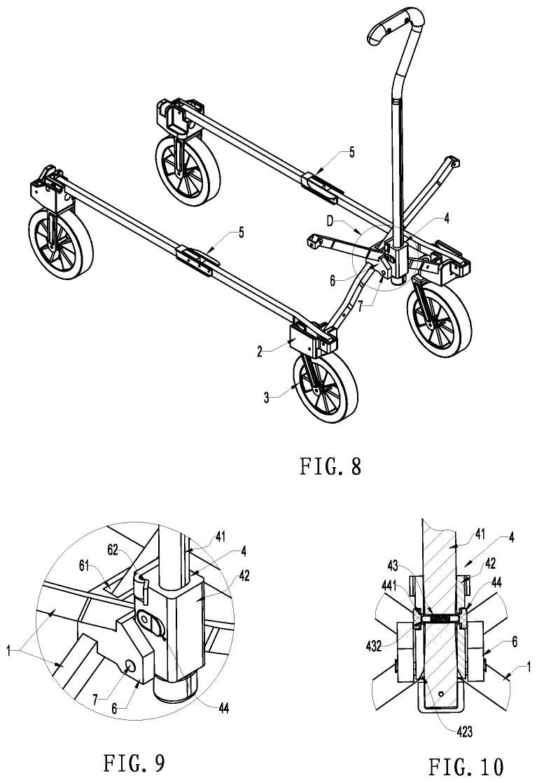

Referring to FIGS. 3, 7, 8, and 11, a uniqueness of this structure is that the bottom plane of the frame 1 is supported by two foldable rod groups 5 distributed left and right. The foldable rod group 5 includes a front rod 51 and a rear rod 52. The bridging piece 53 connects one end of the front rod 51 and the rear rod 52, and the other ends of the front rod 51 and the rear rod 52 are correspondingly hinged on the hinge base 2 on the front and rear vertical surfaces. The hinged base 2 is correspondingly formed with a horizontal slot 21. When the cart body frame 100 is opened in place, the front and rear rods 51 and 52 are partially overlaid in the horizontal slot 21 and supported. In other words, even when the front and rear rods 51 and 52 are not connected by the bridging piece 53, one end can still be maintained in a suspended state by means of a junction point and a local jack. The bridging piece 53 forms an association at the suspension and provides the convenience of lifting up linkage and folding. In other words, the bottom plane of the cart body frame 100 is the restraint mechanism for the frame to open in place. After the two rods of the folding rod group 5 are opened, the bridging end naturally assumes an interference hem to achieve a self-locking state. Only when the bridging end is lifted by an external force can the front and rear rods 51 and 52 draw the front and rear vertical surfaces to collapse and close together.

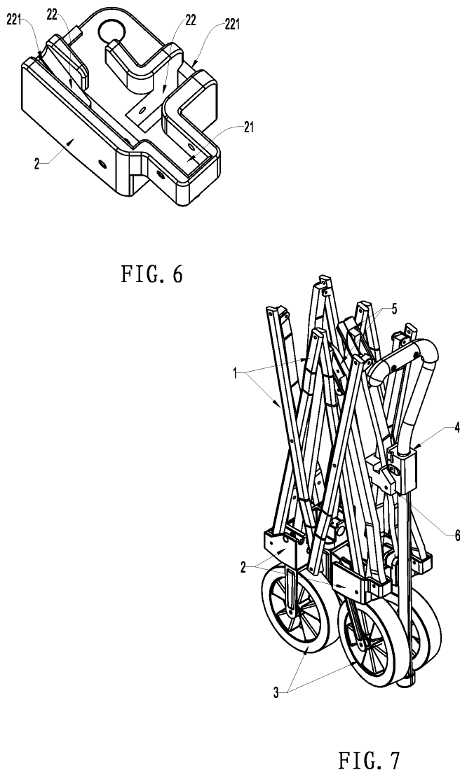

As shown in FIG. 6, the hinge base 2 is correspondingly formed with an inclined slot 22 at the hinge position where the diagonal rods 1 of the adjacent vertical are hinged. The bottom of the inclined slot 22 is provided with a stud 221 at the notch. When the cart body frame 100 is opened in place, the diagonal rod 1 can be supported by the stud 221. The reverse also limits the free swing space of the hinge base 2. The stud 221 can also be an inclined bottom, forming a structure with a deep inner and a shallow slot. The stud 221 design is better as it can save material and reduce weight. Furthermore, the length of the horizontal slot 21 and the inclined slot 22 on the hinge base 2 is greater than 3 cm, preferably in the range of 3 cm-15 cm slot length. The groove wall can reach the restraint, which greatly increases the volume and weight of the hinge base. In other words, the slot walls on both sides of the horizontal slot 21 and the inclined slot 22 can form constraints on the corresponding front and rear rods 51 and 52 or the diagonal rod 1. This forms a three-sided constraint with the bottom of the slot, so that the hinge base 2 can gradually correct towards the designed angle. After the cart body frame 100 is opened in place, it can be maintained in the designed state. The angle of the carters 3 remains unchanged, so as to ensure the smooth running of pushing and pulling.

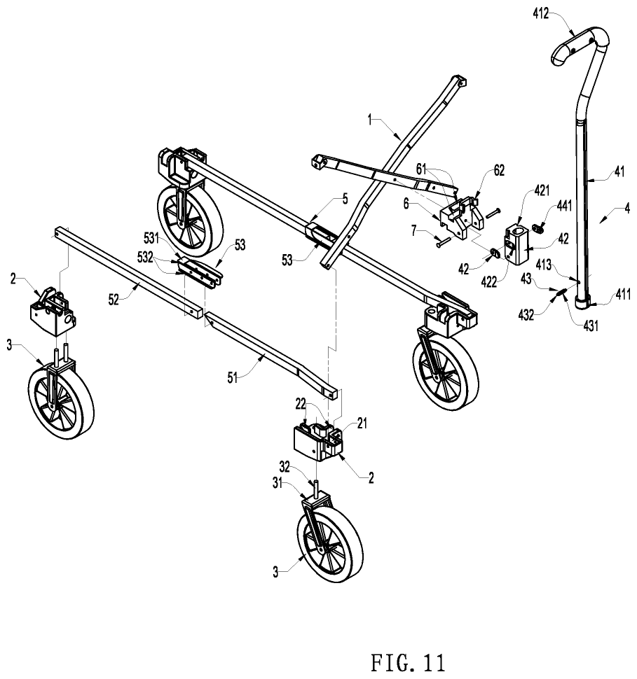

As shown in FIGS. 3 and 11, in general, the two hinge bases 2 on the rear vertical surface of the cart body frame 100 are equipped with directional casters 3, and the casters 3 are directly locked on the hinge base 2 through the caster frame 31. The casters 3 installed on the two-hinge base 2 of the front vertical surface are steering casters. The caster frame 31 is positioned on the hinge base 2 through the rotation shaft 32, so that the casters 3 and the caster frame 31 can rotate freely relative to the hinge base 2 to meet the requirements of the steering of the push cart. Correspondingly, the length of the horizontal slot 21 on the hinge base 2 where the steering casters are located is between 8 cm and 12 cm, which strengthens the guiding effect of the hinge base 2 and enhances its stability. Similarly, if the steering casters 3 are provided on the rear vertical surface of the cart body frame 100, the hinge base with the steering casters will also lengthen the horizontal slot 21.

In order to strengthen the binding force between the horizontal slot 21 and the inclined slot 22 of the hinge base 2 and the rods, a restriction is also made on the rods, the traditional circular rods are not excluded. However, the following examples of rods are better.

As shown in FIGS. 3, 7, 8 and 11, the front and rear rods 51 and 52 and the diagonal rod 1 are all square-like pipe fittings, such as standard rectangular profiles. The two slot walls of the horizontal slot 21 and the inclined slot 22 are relatively fit and constrained, that is, they further eliminate the movement gap. They are used to bridge the bridging pieces at the ends of the front and rear rods 51 and 52 and are formed as a clamping slot with a connecting part 531 on the upper part. They are clamped on both sides of the ends of the front and rear rods 51 and 52 with the aid of the clamping slot, and can be rotated and riveted by rivets. The rear rod 52 is opened to a horizontal position, and its upper part is stopped by the connecting part 531 to restrict continued downward movement. One of the advantages is maintaining the integrity of the bridging piece 53 to facilitate assembly. The second advantage is that the connecting part 531 additionally restricts the downward swing of the end of the rear rod 52. The third advantage is that the horizontal slot 21 matched with the rear rod 53 can be designed to be shorter. In order to strengthen the bridging piece 53, a chamfer 532 is punched on the four edges. In addition, the bridging piece can also directly adopt two symmetrical clips, which are directly clamped on both sides of the rod and riveted. However, the restraint on the rear rod 52 will be lost. In this structure, a longer horizontal slot 21 is required to constrain the rear rod 52.

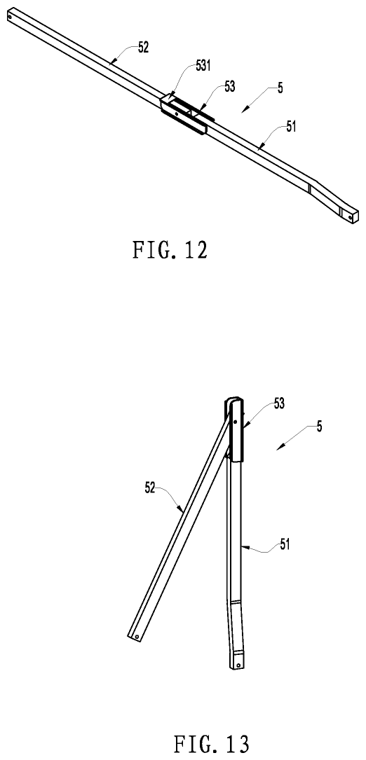

As shown in the embodiment of FIG. 11, the bridging piece 53 is rotatable and riveted by rivets. In particular, the front rod 51 can be directly riveted into a single body, which can reduce the movement gap caused by the movable riveting and can strengthen the binding effect of the connection part 531 to the rear rod 52. In addition, the lower side of the end of the front rod 51 or the rear rod can be processed into a slope to provide folding space. In addition to riveting, the bridging piece 53 and the front rod 51 can be welded together, as shown in FIGS. 12 and 13, to further improve the rigidity and strength of the folding rod group 5. The structure is simpler and is more convenient to assemble.

As shown in Figure s1, 8 and 11, the middle of the two diagonal rods 1 on the front vertical surface of the cart body frame 100 are cross-hinged with a plastic base 6. The plastic base 6 is formed with staggered slots 61 for the two diagonal rods to pass through. When the two diagonal rods 1 are opened to the designed angle, the diagonal rods 1 partially abut at the bottom of the slot 61 to form a restraint and strengthened support, which can also relieve the stress on the hinge point. The plastic base 6 is also formed with an elastic clamp 62 toward the front. With the help of the elastic clamp 62, the push-pull rod assembly 4 is clamped to maintain the push-pull rod assembly 4 in an upright state, which is another key point of the present application.

The push-pull rod assembly 4 includes a pull rod 41 and a slide bushing base 42. The slide bushing base 42 is rotatably positioned on the plastic part base 6 by a riveting shaft 7 and is provided with a retractable waist section 421 corresponding to the elastic clamp 62 of the plastic part base. When the push-pull rod assembly 4 swings to an upright state, the elastic clamp 62 can be clamped at the retractable waist section 421 to form a positioning structure. When the pull rod 41 passes through the slide bushing base 42, the lower end is locked with the limit sheath 411, the upper end is bent with a handle 412, the pull rod 41 is pulled up to a designed height, and the limit sheath 411 is in contact with the lower edge of the slide bushing base 42 to form a pulling force transmission effect. When the push cart is pulled, the pull rod 41 is forced forward, and the slide bushing base 42 is free from the restriction of the clamp 62. Clamp 62 can cater to the force angle around the riveting shaft 7. After releasing the grip of the handle, the pull rod 41 swings freely. One option is to follow the slide bushing 42 and slide down, letting the limit sheath 411 fall to the ground. This state is quite special. The second option is that the pull rod 41 drives the slide bushing base 42 to swing around the riveting shaft 7 under the action of gravity until the limit sheath 411 touches the bottom of the plastic part base 6, keeping the handle 412 in the upturned state, as shown in FIG. 1, to facilitate the need for secondary pulling.

Furthermore, near the lower end of the pull rod 41 is a bidirectional spring pin 13, which includes a spring 431 that crosses the through hole 413 of the pull rod and a ball pin 432 provided at both ends of the spring. When the pull rod 41 is pulled up to the designed height, the ball pin 432 springs into the pinholes 422 reserved on both sides of the slide bushing base 42 to form a locking structure. It is locked on the pull rod 41 at the designed height, which is convenient for re-use. In addition, the locking also allows the pull rod 41 to be used for pushing actions.

There are two functions of the bidirectional spring pin 43. One for general positioning. When the component force on the ball pin is greater than the spring force, it will automatically unlock. The other function is when the ball pin springs deeper, it needs to be manually unlocked. To do this, an unlocking device needs to be set. In this example, the pinhole 422 on the slide bushing base is a penetrating hole, and an unlocking reed 44 is provided on both sides of the slide bushing seat 42. The stud 441 on the inner surface of the unlocking reed 44 extends into the pin hole 422. When the unlocking reed 44 is pressed, the stud 441 moves inward and abuts on the ball pin 432 of the bidirectional spring pin, forcing the ball pin 432 to retreat and unlock. With the latter locking method, the pull rod 41 can use the diagonally backward thrust to push the push cart forward. Also because the ball pin 432 is relatively protruding, it is easy to be stuck on the lower edge of the slide bushing base 42. The entrance of the lower edge of the slide bushing base 42 is designed as a trumpet mouth or a corresponding inclined surface 423, and the inclined surface 423 is used to force the ball pin 432 to retract, as shown in FIG. 10.

Refer to FIG. 1, the storage bag 200 is arranged on the cart body frame 100, which means that the upper edge is hung on the hinge points of the upper end of the diagonal rod 1, and the lower edge is fixed on the front and rear rods 51 and 52. The bottom is tightened by the folding rod groups 5 on both sides, and the hinge points at the upper ends of the folding rod groups 5 and the diagonal rod 1 provide load-bearing needs. Compared with the traditional technology, the bottom of the frame is supported by cross-folding rods. It is flatter than the bottom, and there is no cross-rod support in the middle. A lifting webbing 201 is sewn on the inner bottom of the storage bag at the position of the corresponding bridge 53. When folding, only the lifting webbing 201 needs to be lifted up, and the diagonal rods will be brought together.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims. It is therefore to be understood that the present invention is not limited to the sole embodiment described above, but encompasses any and all embodiments within the scope of the following claims.

I claim:

1. A push cart that comprising:
a foldable cart body frame (100) and a storage bag (200) sleeved on the cart body frame;
the cart body frame (100) has four vertical surfaces: front, rear, left, and right, and a bottom plane;
to the front, rear, left, right sides of the four vertical surfaces include a set of diagonal rods (1) that are cross-hinged in the middle;
the hinged base (2) is equipped with carters (3), and the front vertical surface of the cart body frame (100) is also provided with a push-pull rod (41) assembly (4);
the bottom plane of the cart body frame (100) is supported by two folding rod groups (5) distributed left and right;
the folding rod group (5) includes a front rod (51), a rear rod (52) and a bridging piece (53), and the bridging piece (53) is connected to one end of the front rod (51) and the rear rod (52), and the other end of the front rod (51) and the rear rod (52) are correspondingly hinged on the hinge base (2) on the front and rear vertical surfaces,
the hinge base (2) is correspondingly formed with a horizontal slot (21);
when the cart body frame (100) is opened in place, the front and rear rods (51) (52) are partially lapped in the horizontal slot (21) and are supported.

2. A push cart according to claim 1, wherein:
the hinge base (2) is correspondingly formed with a inclined slot (22) at the hinge position where the diagonal rods (1) of the adjacent vertical surface are hinged;
the bottom of the inclined slot (22) is provided with a stud (221) at the notch; and
when the cart body frame (100) is opened in place, the diagonal rod (1) can be supported by the stud (221).

3. A push cart according to claim 2, wherein:
the length of the horizontal slot (21) and the inclined slot (22) on the hinge base (2) is greater than 3 cm, and the slot walls on both sides can form constraints on the corresponding front and rear rods (51) (52) or diagonal rods (1).

4. A push cart according to claim 3, wherein:
the casters (3) installed on the two hinge bases (2) on the rear vertical surface are directional casters,
the casters are directly locked on the hinge bases (2) through the caster frame (31);
the casters (3) installed on the two-hinge base (2) of the front vertical surface are steering casters;
the caster frame (31) is positioned on the hinge bases (2) through the rotation shaft (32), and
the length of the horizontal slot (21) on the hinge base (2) is between 8 cm and 12 cm.

5. A push cart according to claim 3, wherein:
the front and rear rods (51) (52) and diagonal rods (1) are all square-like pipe fittings,
at least the two sides used for hinged joints have a planar structure, which can fit and be restrained relative to the two slot walls of the horizontal slot (21) and the inclined slot (22);
the bridging piece (53) used to bridge the ends of the front and rear rods (51) (52) is formed into a clamping slot with a connecting part (531) on the upper part, which is clamped on both sides of the ends of the front and rear rods (51) (52) with the aid of the clamping slot, and can be rotated and riveted by rivets;
wherein when the rear rod (52) is opened to a horizontal position, its upper part is touched by the connecting part (531), restricting the continued downward movement.

6. A push cart according to claim 1, wherein:
the middle of the two diagonal rods (1) on the front vertical surface of the cart body frame (100) are cross-hinged with a plastic part base (6);
the plastic part base (6) is formed with a slot hole (61) that is staggered and can pass through the two diagonal rods (1);
the diagonal rods (1) partially rest on the bottom of the slot hole (61) to form a restraint and strengthened support, and
the plastic part base (6) is also formed with an elastic clamp (62) facing forward, and the push-pull rod (41) assembly (4) is clamped by the elastic clamp (62) to maintain the push-pull rod (41) assembly (4) in an upright state.

7. A push cart according to claim 6, wherein:
the push-pull rod (41) assembly (4) includes a pull rod (41) and a slide bushing base (42);
the slide bushing base (42) is rotatably positioned on the plastic part base (6) through a riveting shaft (7) and is provided with a retractable waist section (421) corresponding to the elastic clamp (62) of the plastic part base (6);
when the push-pull rod (41) assembly (4) swings In the upright state, the elastic clamp (62) can be clamped on the waist section (421) to form a positioning structure. When the pull rod (41) passes through the slide bushing base (42), the lower end is locked with the limit sheath (411), the upper end is bent with a handle (412), the pull rod (41) is pulled up to a designed height, and the limit sheath (411) is in contact with the lower edge of the slide bushing base (42).

8. A push cart according to claim 7, wherein:
near the lower end of the pull rod is a bidirectional spring pin (43), which includes a spring (431) that crosses the through hole (413) of the pull rod and a ball pin (432) provided at both ends of the spring;
whereby when the pull rod (41) is pulled up to the designed height, the ball pin (432) springs into the pin holes (422) reserved on both sides of the slide bushing base (42) to form a locking structure.

9. A push cart according to claim 8, wherein:
the pin hole (422) on the slide bushing base is a penetrating hole, and an unlocking reed (44) is provided on both sides of the slide bushing base (42);
the stud (441) on the inner surface of the unlocking reed (44) extends into the pin hole (422);
whereby when the unlocking reed (44) is pressed, the stud (441) moves inward and abuts on the ball pin (432) of the bidirectional spring pin, forcing the ball pin (432) to retreat and unlock.

10. A push cart according to claim 1, wherein:
the storage bag (200) is set on the cart body frame (100), which means that the upper edge is hung on each hinge point at the upper end of the diagonal rod (1);
the lower edge is fixed on the front and rear rods (51) (52), and the bottom is tightened by the folding rod groups (5) on both sides; and
a lifting webbing (201) is sewn on the inner bottom of the storage bag (200) at the position of the corresponding bridging piece (53).
